(19) United States
(12) Patent Application Publication
(10) Pub. No.: US 2025/0210875 A1
(43) Pub. Date: Jun. 26, 2025

(54) RECONFIGURABLE INTELLIGENT SURFACE (RIS) DEVICE WITH LIQUID CRYSTAL

(71) Applicant: YTTEK TECHNOLOGY CORP., HSINCHU COUNTY (TW)

(72) Inventors: HAO-JU HUANG, TAOYUAN CITY (TW); FANG-YAO KUO, HSINCHU COUNTY (TW); WEN-CHIANG CHEN, HSINCHU CITY (TW)

(21) Appl. No.: 18/985,551

(22) Filed: Dec. 18, 2024

Related U.S. Application Data
(60) Provisional application No. 63/614,177, filed on Dec. 22, 2023.

(51) Int. Cl. H01Q 15/00; H01Q 3/46; H01Q 15/14; H01Q 15/22

(52) U.S. Cl. CPC H01Q 15/002; H01Q 3/46; H01Q 15/147; H01Q 15/22

(57) ABSTRACT

The present disclosure provides a communication device including a plurality of unit cells arranged in a matrix along a row direction and a column direction. Each of the unit cells includes a reflective element, a first substrate disposed on the reflective element; a liquid crystal layer disposed over the first substrate; a second substrate disposed over the liquid crystal layer; a first electrode layer between the first substrate and the liquid crystal layer; and a second electrode layer disposed between the second substrate and the liquid crystal layer. The second electrode layer includes a plurality of trenches overlapping a boundary of the first electrode layer from a top-view perspective.

### PRIORITY CLAIM AND CROSS-REFERENCE

This application claims priority to U.S. provisional application No. 63/614,177 filed Dec. 22, 2023, the disclosure of which is hereby incorporated by reference in its entirety.

### TECHNICAL FIELD

This application relates to wireless communication systems, and more particularly, to a reconfigurable intelligent surface (RIS) in a wireless communication network.

### BACKGROUND

Mobile communication requires high reliability and high information transmission rates for services such as virtual or augmented reality. In a wireless environment, however, the strength of a signal received from a transmitter may be lowered due to an obstacle such as a wall, and thus, the reliability and the information transmission rate of a cellular network may be rapidly lowered.

In order to solve this problem, a method of installing additional base stations and repeaters has been used, but such method is not efficient because of the high installation cost and the high power consumption. In order to improve the wireless communication performance in a wireless environment, a reconfigurable intelligent surface, which has fewer restrictions regarding energy saving and is inexpensive, is attracting attention.

### SUMMARY

According to embodiments of the present disclosure, a communication device includes a plurality of unit cells arranged in a matrix along a row direction and a column direction. Each of the unit cells includes a reflective element, a first substrate disposed on the reflective element; a liquid crystal layer disposed on the first substrate; a second substrate disposed over the liquid crystal layer; a first electrode layer between the first substrate and the liquid crystal layer and comprising a first pattern; and a second electrode layer between the second substrate and the liquid crystal layer and comprising a second pattern, wherein the second pattern defines a plurality of trenches overlapping a boundary of the first electrode layer from a top-view perspective.

According to embodiments of the present disclosure, a communication device includes a plurality of unit cells arranged in a matrix along a row direction and a column direction. Each of the unit cells includes a reflective element and a plurality of panels vertically stacked on the reflective element. The panel includes a first substrate; a second substrate over the first substrate; a liquid crystal layer between the first substrate and the second substrate; a first electrode layer comprising a first pattern between the first substrate and the liquid crystal layer; and a second electrode layer comprising a second pattern between the second substrate and the liquid crystal layer, wherein the second pattern comprises a plurality of trenches overlapping a boundary of the first pattern from a top-view perspective.

The communication device includes a plurality of unit cells, and each unit cell may individually provide desired phase shifts for incident EM signals. The communication device may form desired beams and direct the beams to a desired direction towards a destination using the unit cells with specific phase distributions.

### BRIEF DESCRIPTION OF THE DRAWINGS

Details and features of the present disclosure are provided in the following description, and are presented in combination with the accompanying figures for ease of understanding. It should be noted that, in accordance with common practice, some features are not drawn to scale. Please bear in mind while viewing the figures that dimensions of various features may be arbitrarily increased or reduced for clarity of discussion.

FIG. 1 is a schematic diagram of a communication system, in accordance with some embodiments of the present disclosure.

FIG. 2 is a schematic top view of an auxiliary communication device, in according with some embodiments of the present disclosure.

FIG. 3 is a schematic perspective view of a unit cell, in accordance with some embodiments of the present disclosure.

FIG. 4 is a schematic cross-sectional view of a unit cell, in accordance with some embodiments of the present disclosure.

FIG. 5 is a schematic top view of a first pattern of a first electrode layer, in accordance with some embodiments of the present disclosure.

FIG. 6 is a schematic top view of a second pattern of a second electrode layer, in accordance with some embodiments of the present disclosure.

FIG. 7 is a schematic top view of an inner section and a plurality of connecting sections of a second electrode layer, in accordance with some embodiments of the present disclosure.

FIG. 8 is a schematic top view of a portion of the second electrode layer, in accordance with some embodiments of the present disclosure.

FIG. 9 is a schematic top view of a first electrode layer and a second electrode layer, in accordance with some embodiments of the present disclosure.

FIG. 10 illustrates a phase response plot of a unit cell, in accordance with some embodiments of the present disclosure.

FIG. 11 illustrates a magnitude response plot of a unit cell, in accordance with some embodiments of the present disclosure.

FIG. 12 is a schematic top view of a first electrode layer and a second electrode layer, in accordance with some embodiments of the present disclosure.

FIGS. 13 to 17 illustrate frequency response plots of a unit cell, in accordance with some embodiments of the present disclosure.

FIG. 18 shows schematic top views of a first electrode layer and a second electrode layer, in accordance with some embodiments of the present disclosure.

FIG. 19 illustrates a frequency response plot of a unit cell, in accordance with some embodiments of the present disclosure.

FIG. 20 is a schematic perspective view of a unit cell, in accordance with some embodiments of the present disclosure.

FIG. 21 illustrates a phase response plot of a unit cell, in accordance with some embodiments of the present disclosure.

FIG. 22 illustrates a magnitude response plot of a unit cell, in accordance with some embodiments of the present disclosure.

FIG. 23 is a schematic perspective view of a unit cell, in accordance with some embodiments of the present disclosure.

FIG. 24 is a schematic perspective view of a polarizer, in accordance with some embodiments of the present disclosure.

FIG. 25 is a schematic top view of a first pattern of a first electrode layer, in accordance with some embodiments of the present disclosure.

FIG. 26 is a schematic top view of a second pattern of a second electrode layer, in accordance with some embodiments of the present disclosure.

FIG. 27 is a schematic top view of the first electrode layer and a second electrode layer, in accordance with some embodiments of the present disclosure.

FIG. 28 illustrates a phase response plot of a unit cell, in accordance with some embodiments of the present disclosure.

FIG. 29 illustrates a magnitude response plot of a unit cell, in accordance with some embodiments of the present disclosure.

### DETAILED DESCRIPTION

The following disclosure provides many different embodiments, or examples, for implementing different features of the provided subject matter. Specific examples of components and arrangements are described in the present disclosure in order to facilitate understanding of the invention. Such examples are merely provided to aid in understanding and are not intended to limit the present disclosure. For example, the formation of a first feature over or on a second feature as described herein may include embodiments in which the first and second features are formed in direct contact, and may also include embodiments in which additional features are formed between the first and second features, such that the first and second features are not in direct contact. In addition, the present disclosure may repeat reference numerals and/or letters in the various examples. Such repetition is for the purpose of simplicity and clarity and does not necessarily indicate a relationship between the various embodiments and/or configurations described.

Further, spatially relative terms, such as “beneath,” “below,” “lower,” “above,” “upper” and the like, may be used herein for ease of description to describe one element or feature's relationship to another element(s) or feature(s) as illustrated in the figures. Such spatially relative terms are intended to encompass different orientations of the device in use or operation in addition to the orientation depicted in the figures. The apparatus may be otherwise oriented (for example, rotated 90 degrees from the depicted orientation) and the spatially relative descriptors used herein should accordingly be interpreted as including other orientations.

Notwithstanding that the numerical ranges and parameters setting forth the broad scope of the disclosure are approximations, the numerical values set forth in the specific examples are reported as precisely as possible. Any numerical value, however, inherently contains certain errors necessarily resulting from the deviation normally found in the respective testing measurements. Also, as used herein, the terms “about,” “approximately” or “substantially” may mean within some small percentage of a given value or range. Alternatively, the terms “about,” “approximately” or “substantially” mean within an acceptable standard error of the value indicated when considered by one of ordinary skill in the art. Unless expressly specified otherwise, all of the numerical ranges, amounts, values and percentages such as those for quantities of materials, durations of time, temperatures, operating conditions, ratios of amounts, and the likes thereof disclosed herein should be understood as modified in all instances by the terms “about,” “approximately” or “substantially.” Accordingly, unless indicated otherwise, the numerical parameters set forth in the present disclosure and attached claims are approximations that can vary. At the very least, each numerical parameter should be construed in light of the number of reported significant digits and by applying ordinary rounding techniques. Ranges are expressed herein as from one endpoint to another endpoint, or as between one endpoint and another endpoint. All ranges disclosed herein are inclusive of the endpoints, unless specified otherwise.

As used herein, the term “connected” may be construed as “electrically connected,” and the term “coupled” may also be construed as “electrically coupled.” “Connected” and “coupled” may also be used to indicate that two or more elements cooperate or interact with each other. The terms “couple” or “connect” used throughout the present disclosure may also refer to physical or electrical linkage between two or more objects. These objects may also be referred to as being “coupled” or “connected” through exchange of data or information. These “coupled” or “connected” objects may be in direct contact in some cases or indirect contact through other intervening objects.

The present disclosure is directed to a liquid crystal-based reconfigurable intelligent surface (LC-RIS) device used in a wireless communication system. The LC-RIS device is an auxiliary communication device and configured to direct a signal between a transmitter and a receiver. The LC-RIS device includes a plurality of unit cells arranged in a matrix along a row direction and a column direction. Each of the cell units includes a first electrode layer, a second electrode layer, and a liquid crystal layer between the first electrode layer and the second electrode layer. The first electrode layer includes a first pattern, and the second electrode layer includes a second pattern overlapping the first pattern from a top-view perspective. The second pattern of the second electrode layer defines a plurality of the trenches that overlapping a boundary of the first pattern of the first electrode layer. The LC-RIS device of the present disclosure may support the dual-polarization as compared with the conventional split ring resonators consisting of a pair of concentric metallic rings and supporting the single polarization only.

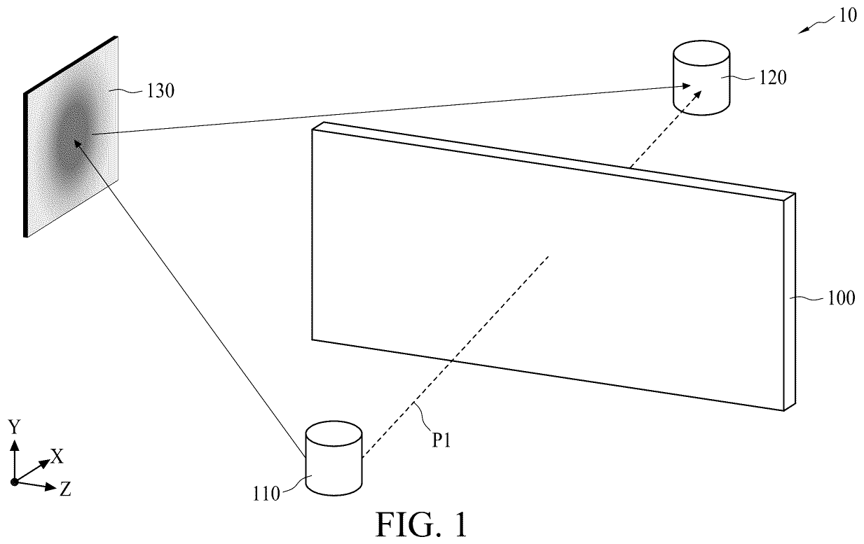

FIG. 1 is a schematic diagram of a communication system 10, in accordance with some embodiments of the present disclosure. Referring to FIG. 1, in some embodiments, the communication system 10 is a wireless communication system that supports a high-frequency band (e.g., a millimeter wave (mmWave) band) in order to achieve a high data transmission rate. The communication system 10 may include a transmitter 110, a receiver 120, and an auxiliary communication device 130. The transmitter 110 is configured to communicate with the receiver 120 using an electromagnetic (EM) signal in an mmWave band. The EM signal in the mmWave band typically has poor penetration and diffraction abilities, and the transmitter 110 is unable to communicate directly with the receiver 120 when an obstacle 100 (e.g., a building, a tree, etc.) is present on a path P1 along which the signal is directly transmitted. However, the transmitter 110 and the receiver 120 can communicate using the auxiliary communication device 130.

The auxiliary communication device 130 is used to direct the EM signal from the transmitter 110 to the receiver 120. In some embodiments, when the transmitter 110 and the receiver 120 aren't at the specular positions relative to the auxiliary communication device 130, the auxiliary communication device 130 functions as a programmable reflector to reflect the EM signal transmitted from the transmitter 110 for directing the EM signal toward the receiver 120. The auxiliary communication device 130 may be configured to provide desired phase shift distributions for the incident EM signals to be directed in a desired direction towards the receiver 120. In other words, the auxiliary communication device 130 is configured to change a phase distribution or a direction of the incident EM signals, which are discussed below. The auxiliary communication device 130 may include a reconfigurable intelligent surface (RIS) device. For example, the auxiliary communication device 130 may include a liquid-crystal-based RIS device.

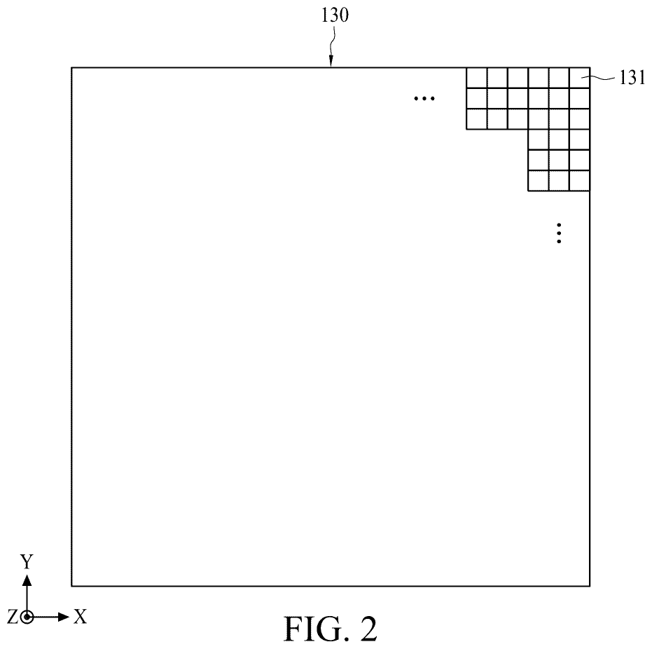

FIG. 2 is a schematic top view of an auxiliary communication device 130, in according with some embodiments of the present disclosure. Referring to FIG. 2, the auxiliary communication device 130 includes a plurality of unit cells 131. The plurality of unit cells 131 are arranged in a matrix of rows and columns. Each of the unit cells 131 may be configured to provide desired phase shift for the incident EM signal to be directed in a desired direction towards the receiver 120. The EM signals that exit the unit cells 131 may thus be in phase for producing a condition of constructive interference. The constructive interference of EM signals occurs when two or more EM signals are in phase with each other and converge into a combined signal such that an amplitude of the combined signal is greater than an amplitude of each EM single signal. Each of the unit cells 131 may be independently controllable and operable to change a phase the incident EM signal.

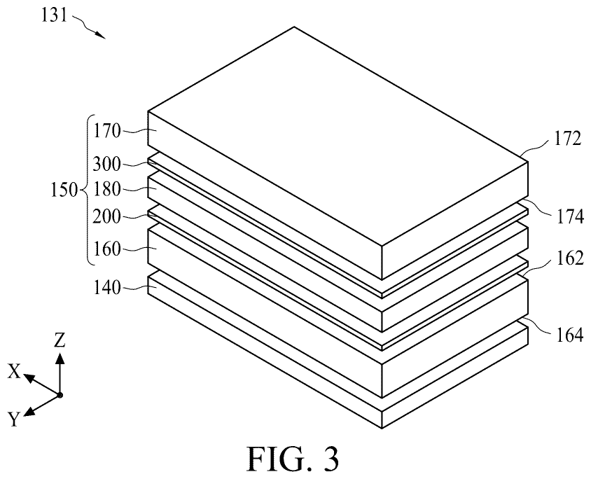

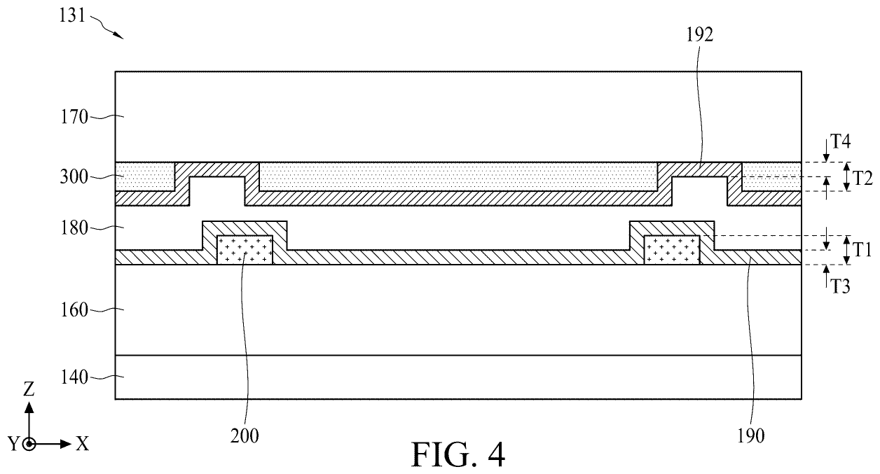

FIG. 3 is a schematic perspective view of the unit cell 131, in accordance with some embodiments of the present disclosure, and FIG. 4 is a schematic cross-sectional view of the unit cell 131, in accordance with some embodiments of the present disclosure. Referring to FIGS. 3 and 4, each of the unit cell 131 includes a reflective element 140 and a liquid crystal panel 150 disposed on the reflective element 140, wherein the liquid crystal panel 150 is arranged to face toward the transmitter 110 and the receiver 120 shown in FIG. 1. The reflective element 140 is used to reflect the EM signals penetrating through the liquid crystal panel 150 to generate reflected EM signals, which are discussed below. The reflected EM signals are reflected back to the liquid crystal panel 150 and then transmitted to the receiver 120 shown in FIG. 1. In some embodiments, the reflective element 140 has at least 90% reflectivity at selected wavelengths of the EM signals. The reflective element 140 may include a reflective medium containing a metal such as aluminum (Al), copper (Cu), silver (Ag), gold (Au), or any other suitable material having a reflective property at desired EM wavelengths. The reflective elements 140 of adjacent unit cells 131 may be connected or integrated together and act as a shared reflector for the unit cells 131.

In some embodiments, the liquid crystal panel 150 includes a first substrate 160, a second substrate 170, a liquid crystal layer 180, a first isolation layer 190, a second isolation layer 192, a first electrode layer 200, and a second electrode layer 300. The first substrate 160 is disposed on the reflective element 140 and includes a front surface 162 and a back surface 164 opposite to the front surface 162. The back surface 164 of the first substrate 160 is proximal to the reflective element 140, and the front surface 162 of the first substrate 160 is distal from the reflective element 140. The first substrates 160 of adjacent unit cells 131 may be connected or integrated together and act as a shared substrate for the unit cells 131.

The second substrate 170 is disposed over the first substrate 160 and includes a front surface 172 and a back surface 174 opposite to the front surface 172. The back surface 174 of the second substrate 170 is proximal to the first substrate 160, and the front surface 172 is distal from the first substrate 160. The second substrates 170 of adjacent unit cells 131 may be connected or integrated together and act as a shared substrate for the unit cells 131. The first substrate 160 and the second substrate 170 are insulated substrates. Each of the first substrate 160 and the second substrate 170 includes an insulating material. For example, the first substrate 160 and the second substrate 170 may include glass, quartz, plastic, polyethylene terephthalate resin, polyethylene resin, or polycarbonate resin.

The liquid crystal layer 180 is disposed between the first substrate 160 and the second substrate 170. In some embodiments, the first isolation layer 190 and the first electrode layer 200 are disposed between the first substrate 160 and the liquid crystal layer 180, and the second isolation layer 192 and the second electrode layer 300 are disposed between the second substrate 170 and the liquid crystal layer 180.

In some embodiments, the first isolation layer 190 and the first electrode layer 200 are attached to the front surface 162 of the first substrate 160. The first isolation layer 190 may be conformal to the front surface 162 of the first substrate 160 and the first electrode layer 200. For example, the first isolation layer 190 may have a topology following topologies of front surface 162 of the first substrate 160 and the first electrode layer 200.

In some embodiments, the second isolation layer 192 and the second electrode layer 300 may be attached to the back surface 174 of the second substrate 170. The second isolation layer 192 may be conformal to the back surface 174 of the second substrate 170 and the second electrode layer 300. For example, the second isolation layer 192 may have a topology following topologies of the back surface 174 of the second substrate 170 and the second electrode layer 300.

The first electrode layer 200 and the second electrode layer 300 are made of conductive material, such as Al, Cu, indium-tin oxide (ITO), or other conductive materials suitable for use in electrodes in the liquid crystal panel 150. The first electrode layer 200 and the second electrode layer 300 made of ITO is, for example, utilized for applications in which the auxiliary communication device 130 is mounted on transparent medium, such as a window of vehicle, a window of building.

The liquid crystal layer 180 may be composed of liquid crystal molecules that have long range ordered alignment. The liquid crystal molecules may be in contact with the first isolation layer 190 and the second isolation layer 192. The first isolation layer 190 may isolate the liquid crystal molecules from the first substrate 160 and the first electrode layer 200. The second isolation layer 192 may isolate the liquid crystal molecules from the second substrate 170 and the second electrode layer 300.

The first electrode layer 200 has a thickness T1, and the second electrode layer 300 has a thickness T2. The first isolation layer 190 may have a thickness T3 less than the thickness T1 of the first electrode layer 200. The second isolation layer 192 may have a thickness T4 less than the thickness T2 of the second electrode layer 300. The first isolation layer 190 and the second isolation layer 192 include insulating material. The liquid crystal layer 180 of adjacent unit cells 131 may be merged or integrated together and act as a shared liquid crystal layer for the unit cells 131.

When voltages are applied to the first electrode 200 and the second electrode 300, respectively, an electric field may be generated in the liquid crystal layer 180. When the voltage of the first electrode layer 200 relative to the second electrode layer 300 changes, the alignment of the liquid crystal molecules changes accordingly. In other words, the liquid crystal molecules may be oriented or aligned by the strength of the electrical field. Since the liquid crystal molecules are polar molecules and have dielectric anisotropy, a dielectric constant of the liquid crystal layer 180 varies depending on the alignment state of the liquid crystal molecules. In other words, the dielectric constant of the liquid crustal layer 180 is changed according to an applied electric field. An orientation of the liquid crystal molecules in the liquid crystal layer 180 may ultimately impact a reflective phase of the EM signal that exit the liquid crystal panel 150 and pass through the second substrate 170. Thus, by modulating the electric field applied to the liquid crystal layer 180, the reflective phase of the EM signal transmitted to the receiver 120 may be varied accordingly. An EM signal may incident the liquid crystal panel 150 by an incident phase, and exit the liquid crystal panel 150 by the reflective phase. The liquid crystal layer 180 may be configured to adjust the reflective phase of the EM signal, so that the reflective phase may not be equal to the incident phase. The EM signal may thus be focused or transmitted to any desired direction.

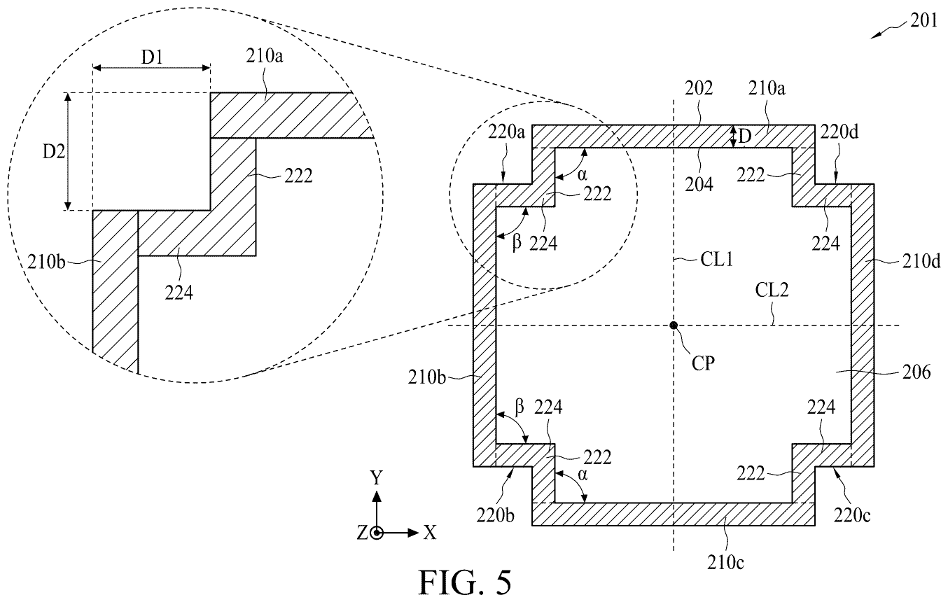

The first electrode layer 200 includes a first pattern 201. FIG. 5 is a top view of the first pattern 201 of the electrode layer 200, in accordance with some embodiments of the present disclosure. Referring to FIG. 5, in some embodiments, the first electrode pattern 201 has a ring shape with an outer boundary 202 and an inner boundary 204 separated by a substantially uniform distance or width D. The inner boundary 204 defines an opening 206 that extends through the first electrode layer 200. The opening 206 may have a cross shape from a top-view perspective.

The first pattern 201 includes a plurality of major sections 210a to 210d and a plurality of angled sections 220a to 220d. The major sections 210a to 210d may be substantially straight. The major section 210a is parallel to the major section 210c, and the major section 210b is parallel to the major section 210d. The major section 210a may be orthogonal to the major section 210b.

Each of the angled sections 220a to 220d is arranged between two of the major sections 210a to 210d. Each of the angled sections 220a to 220d connects two adjacent and orthogonal major sections 220a to 220d. For example, the angled section 220a may connect the major section 210a extending in the X-direction to the major section 210b extending in the Y-direction. Further, the angled section 220b may connect the major sections 210b and 210c, the angled section 220c may connect the major sections 210c and 210d, and the angled section 220d may connect the major sections 210a and 210d.

In some embodiments, the first pattern 201 has a center point CP that lies at an intersection of a hypothetic center line CL1 of the major section 210a/210c extending in the Y-direction and a hypothetic center line CL2 of the major section 210b/210d extending in the X-direction. Each of the angled sections 220a to 220d may have an L-shaped profile from a top-view perspective, with a vertex pointing to the center point CP of the first pattern 201. The first pattern 201 may have mirror symmetry about the hypothetic center line CL1 and the hypothetic center line CL2.

Each of the angled sections 220a to 220d may have a first portion 222 extending in the Y-direction and a second portion 224 extending in the X-direction and connected to the first portion 222. In some embodiments, the first portions 222 are spaced apart from edges of each major section 210b/210d by a first distance D1. The first portion 222 of each angled section 220a to 220d is further connected to either the major section 210a or the major section 210c and forms an included angle a. The second portions 224 are spaced apart from edges of each major section 210a/210c by a second distance D2. The second portion 224 of each angled section 220a to 220d is further connected to either the major section 210b or the major section 210d and forms an included angle β. The included angles a and β may each be a right angle of about 90 degrees.

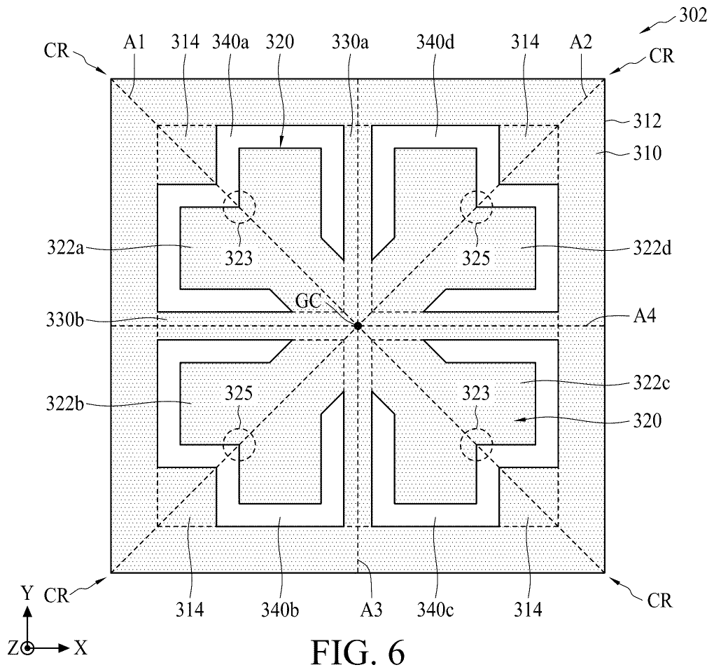

FIG. 6 is a schematic top view of a second pattern 302 of the second electrode layer 300, in accordance with some embodiments of the present disclosure. Referring to FIG. 6, in some embodiments, the second pattern 302 includes an outer section 310, an inner section 320, and a pair of connecting sections 330a and 330b. The outer section 310, the inner section 320, and the connecting sections 330a and 330b may collectively define a plurality of trenches 340a to 340d. The outer section 310 laterally surrounds the inner section 320. The connecting sections 330a and 330b connect the outer section 310 to the inner section 320.

The outer section 310 has an outer boundary 312. The outer boundary 312 may have a substantially square shape with four corners from a top-view perspective. The corners may be formed by a pair of adjacent and orthogonal sides of the boundary 312. The second electrode layer 300 may include a geometric center GC at an intersection of diagonals A1 and A2 of the square shape and a plurality of corner regions CR. Each corner region CR may include one of the corners of the outer boundary 312.

The outer section 310 may have a substantially square ring shape with widened portions 314 at corner regions CR of the second electrode layer 300. The widened portions 314 may have a square shape from a top-view perspective.

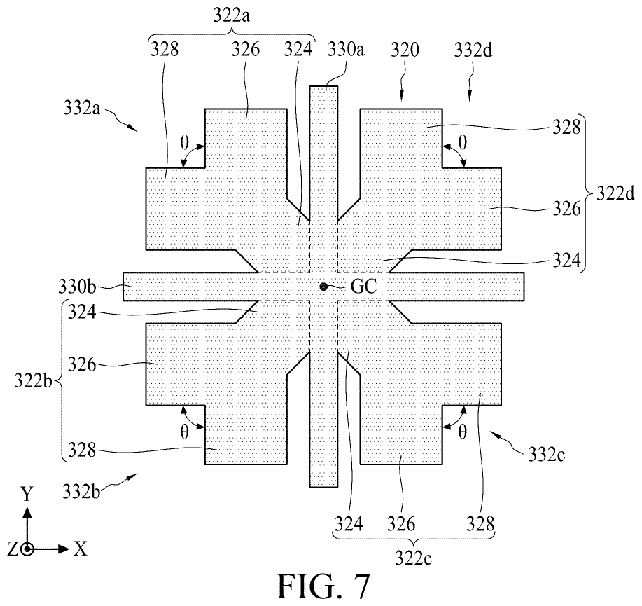

FIG. 7 is a schematic top view of the inner section 320 and the connecting sections 330a and 330b, in accordance with some embodiments of the present disclosure. Referring to FIG. 7, in some embodiments, the connecting sections 330a and 330b are substantially orthogonal. The connecting section 330a is connected to the connecting section 330b, forming a cross shape with an intersection at the geometric center GC of the second electrode layer 300. The connecting section 330a and 330b with the cross shape may define four quadrant areas 332a to 332d.

In some embodiments, the inner section 320 includes a plurality of

Y-shaped structures 322a to 322d, from a top-view perspective, arranged in the quadrant areas 332a to 332d, respectively. Each of the Y-shaped structures 322a to 322d includes a base portion 324, a first branch portion 326, and a second branch portion 328 connected together. The base portions 324 of the Y-shaped structures 322a to 322d are further connected to the connecting sections 330a and 330b. An included angle θ may be formed between the first branch portion 326 and the second branch portion 328. In some embodiments, the included angle θ is approximately 90 degrees. The present disclosure, however, is not limited thereto.

Referring to FIGS. 6 and 7, each of the Y-shaped structures 322a and 322c may be oriented to have an intersection 323, between the first branch portion 326 and the second branch portion 328, on the diagonal A1. Further, each of the Y-shaped structures 322b and 322d may be oriented to have an intersection 325, between the first branch portion 326 and the second branch portion 328, on the diagonal A2.

The trenches 340a to 340d are arranged at the corner regions CR of the second electrode layer 300. The trenches 340a to 340d may separate each of the Y-shaped structure 322a to 322d from the outer section 310 and the connecting sections 330a and 330b. The trenches 340a to 340d may include a boundary or profile defined by the outer section 310, the inner section 320, and the connecting sections 330a and 330b.

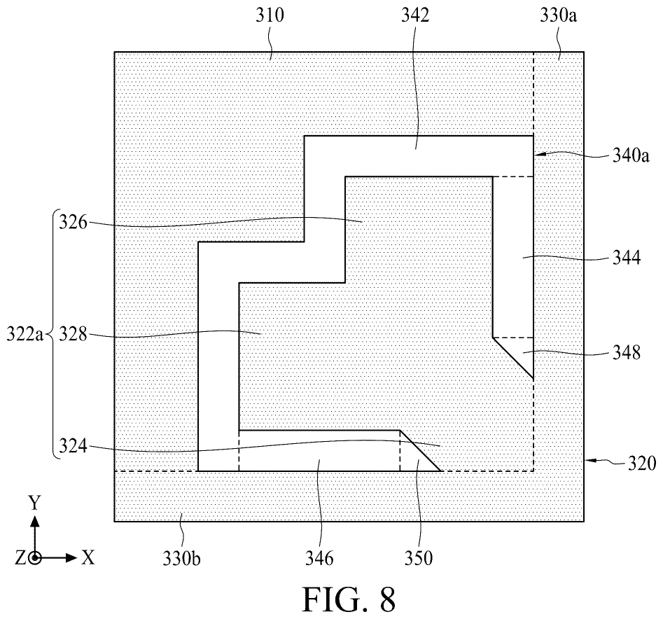

FIG. 8 is a schematic top view of a portion of the second electrode layer 300 that includes the trench 340a, in accordance with some embodiments of the present disclosure. Referring to FIG. 8, in some embodiments, the trench 340a includes a plurality of portions, such as a first portion 342, a second portion 344, a third portion 346, a fourth portion 348 and a fifth portion 350, connected to each other. The first portion 342 is arranged between the outer section 310 and the Y-shaped structure 322a. The first portion 342 may include a stepped profile from a top-view perspective.

The second portion 344 may be arranged between the connecting section 330a and the first branch portion 324 of the Y-shaped structure 322a. The third portion 346 may be arranged between the connecting section 330b and the second branch portion 326 of the Y-shaped structure 322a. In some embodiments, the second portion 344 and the third portion 346 of the trench 340a include a substantially rectangular profile from a top-view perspective. The fourth portion 348 may be arranged between the connecting section 330a and the base portion 328 of the Y-shaped structure 322a. The fifth portion 350 may be arranged between the connecting section 330b and the base portion 328 of the Y-shaped structure 322a. In some embodiments, the fourth portion 348 and the fifth portion 350 of the trench 340a include a substantially triangular profile from a top-view perspective.

Referring to FIGS. 6 and 8, the trenches 340b to 340d may have a profile substantially same as that of the trench 340a. The trenches 340b may include a profile that matches the profile of the trench 340a rotated by about 270 degrees. The trench 340c may include a profile that matches the profile of the trench 340a rotated by about 180 degrees. The trench 340d may include a profile that matches the profile of trench 340a rotated by about 90 degrees. In some embodiments, the outer section 310, the inner section 320, the connecting sections 330a and 330b, and the trenches 340a to 340d are symmetrical relative to the diagonals A1 and A2. The second electrode layer 300 may further includes a hypothetic center line A3 extending in the X-direction and a hypothetic center line A4 extending in the Y-direction. The hypothetic center lines A3 and A4 intersect at the geometric center GC. The outer section 310, the inner section 320, the connecting sections 330a and 330b, and the trenches 340a to 340d may further have a mirror symmetry about the hypothetic center line A3 and the hypothetic center line A4.

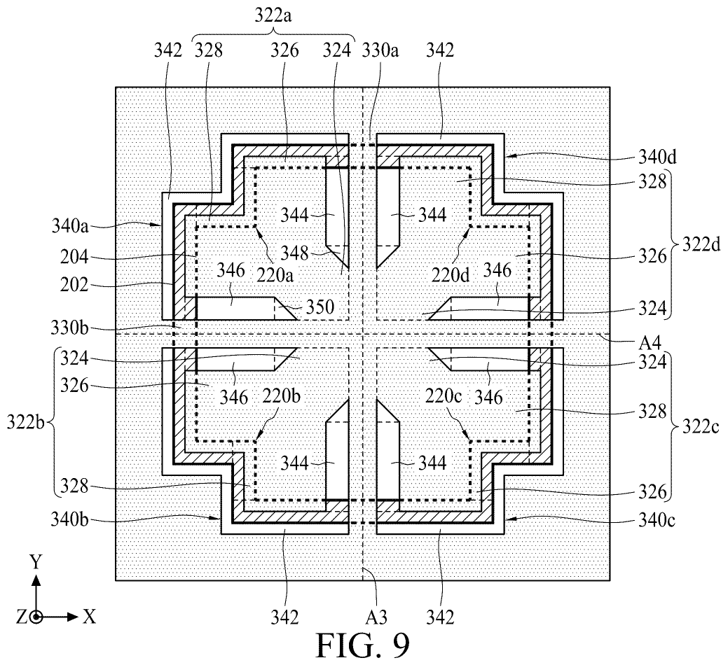

FIG. 9 is a schematic top view of the first electrode layer 200 and the second electrode layer 300, in accordance with some embodiments of the present disclosure. Referring to FIG. 9, in some embodiments, the second electrode layer 300 is disposed over the first electrode layer 200, and the geometric center GC of the second electrode layer 300 is vertically aligned with the center point CP of the first electrode layer 200. The first portions 342 of the trenches 340a to 340d of the second pattern 302 may overlap the outer boundary 202 of the first pattern 201 from a top-view perspective. The first portions 342 of the trenches 340a to 340d may have a profile following the angled sections 220a to 220d.

Each of the second portions 344 and the third portions 346 of the trenches 340a to 340d of the second electrode layer 300 may vertically overlap the inner boundary 204 of the first electrode layer 200. Further, the first branch portion 326 and the second branch portion 328 of the Y-shaped structures 322a to 322d of the second electrode layer 300 may vertically overlap the inner boundary 204 of the first electrode layer 200. A length of the outer boundary 202 that vertically overlaps the trenches 340a to 340d is greater than a length of the inner boundary 204 that vertically overlaps the trenches 340a to 340d.

In some embodiments, when an EM signal is incident perpendicular to the unit cell 131, an overlapping area of the first and second electrode layers 200 and 300 and gaps between the trenches 340a to 340d and the first electrode layer 200 may produce an electric field and an equivalent capacitor to modulate the phase of the EM signal. The gaps between the trenches 340a to 340d and the first electrode layer 200 are configured to modulate a distribution of the electric field generated by the first electrode layer 200 and the second electrode layer 300. The gaps extending in the X-direction may provide a vertical electric field, and the gaps extending in the Y-direction may provide a horizontal electric field. Due to the first electrode layer 200 and the second electrode layer 300 has mirror symmetry about the hypothetic center line A1/A3 and the hypothetic center line A2/A4 of the second electrode layer 300, the unit cell 131 may support the dual-polarization.

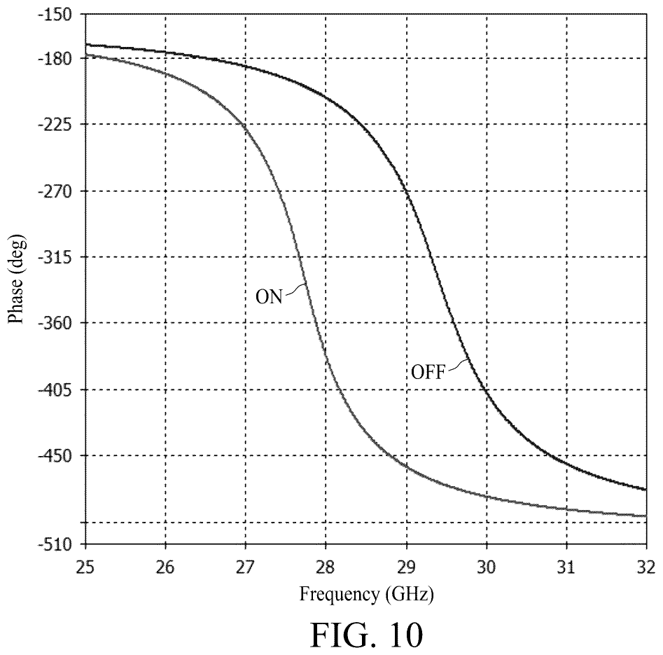

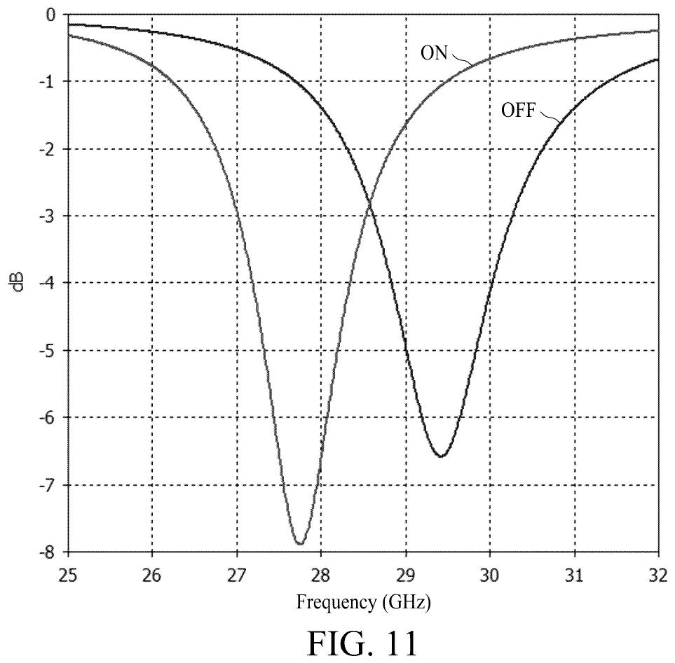

FIG. 10 illustrates a phase response plot of the unit cell 131, in accordance with some embodiments of the present disclosure, and FIG. 11 illustrates a magnitude response plot of the unit cell 131, in accordance with some embodiments of the present disclosure. The two lines shown in FIGS. 10 and 11 as labeled represent the simulation results for the unit cell 131 including the first electrode layer 200 with the first pattern 201 and the second electrode layer 300 with the second pattern 302 in a power-on state and in a power-off state, respectively. Referring to FIG. 10, at the frequency ranging from about 28 GHz to about 29 GHz, the unit cell 131 may shift a phase of an incoming EM signal to have a phase difference of about 180 degrees between the power-on and power-off states. The unit cells 131 with a broad phase tuning range of the incoming EM signal may facilitate control of the phase of the incoming EM signal in order to produce the constructive interference.

However, as shown in FIG. 11, the unit cell 131 in the power-off state has a resonant frequency at about 29.5 GHz, the unit cell 131 in the power-on state has a resonant frequency at about 27.8 GHz. The signal amplitude of the unit cell 131 in those resonant frequencies attenuates greatly, resulting in a phenomenon that shortens the communication distance drastically.

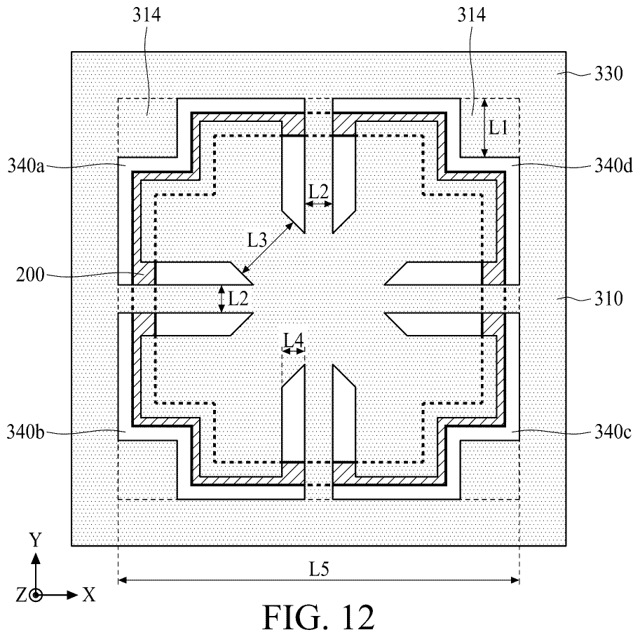

FIG. 12 is a schematic top view of the first electrode layer 200 and the second electrode layer 300, in accordance with some embodiments of the present disclosure. Referring to FIG. 12, in some embodiments, each of the widened portions 314 of the outer section 310 of the second electrode layer 300 has a length L1 in the Y-direction, and the connecting section 330a of the second electrode layer 300 has a length L2 in the X-direction. The base portions 324 of the Y-shaped structure 322a to 322b in the second electrode layer 300 may have a length L3. Each of the trenches 340a to 340d of the second electrode layer 300 has a substantially uniform length L4. The second electrode layer 300 may have a frame size L5. The lengths L1, L2, L3, L4, and L5 may affect a resonant frequency of the unit cell 131. In some embodiments, the first electrode layer 200 may have a line width substantially equal to the length L2 throughout the major sections 210a to 210d and the angled sections 220a to 220d.

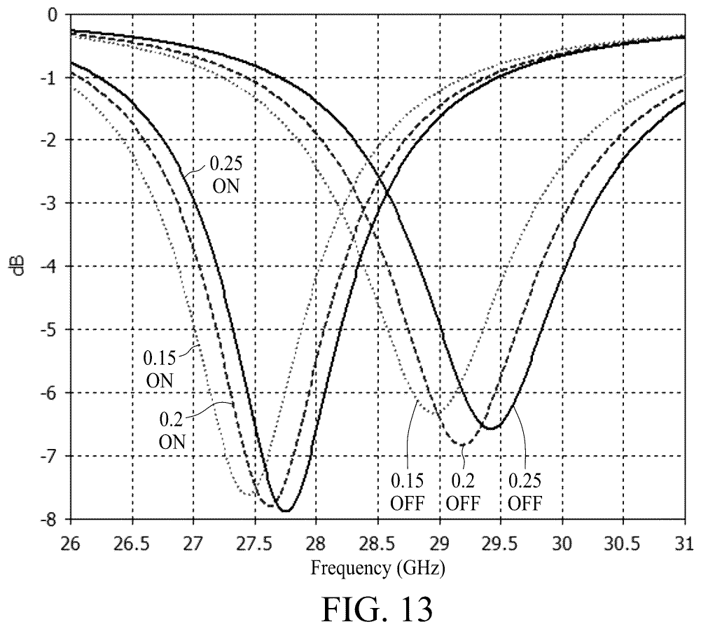

FIG. 13 is a schematic diagram of a simulation result for the unit cell 131 that includes the second electrode layer 300 containing the widened portions 314 with different lengths L1 in accordance with some embodiments of the present disclosure. Referring to FIGS. 12 and 13, the six lines as labeled represent the simulation results for the widened portions 314 having the length L1 of 0.15 mm, 0.2 mm, and 0.25 mm in a power-on state and in a power-off state. As shown in FIG. 13, the resonant frequency of the unit cell 131 shifts toward a low frequency when the length L1 is reduced.

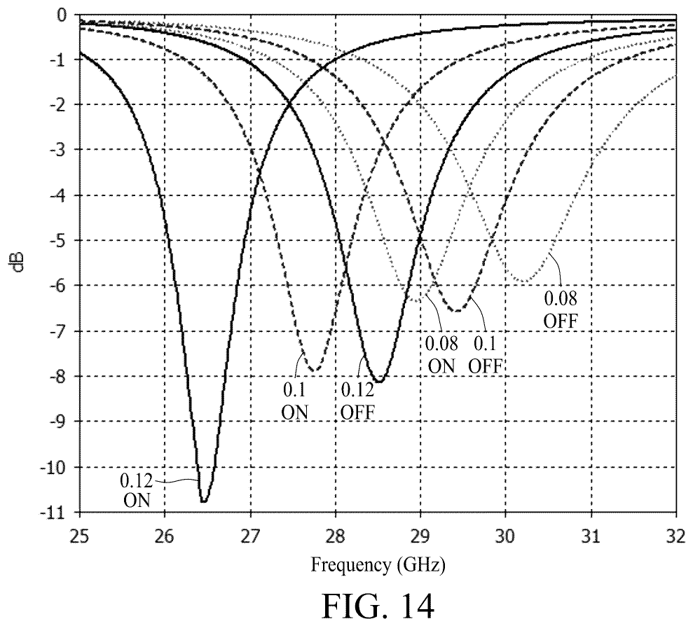

FIG. 14 is a schematic diagram of a simulation result for the unit cell 131 that includes the second electrode layer 300 containing the connecting section 330a with different lengths L2 in accordance with some embodiments of the present disclosure. Referring to FIGS. 12 and 14, the six lines as labeled represent the simulation results for the connecting portions 330a and 330b having the length L2 of 0.08 mm, 0.1 mm, and 0.12 mm in a power-on state and in a power-off state. As shown in FIG. 14, the resonant frequency of the unit cell 131 shifts toward a high frequency when the length L2 is reduced.

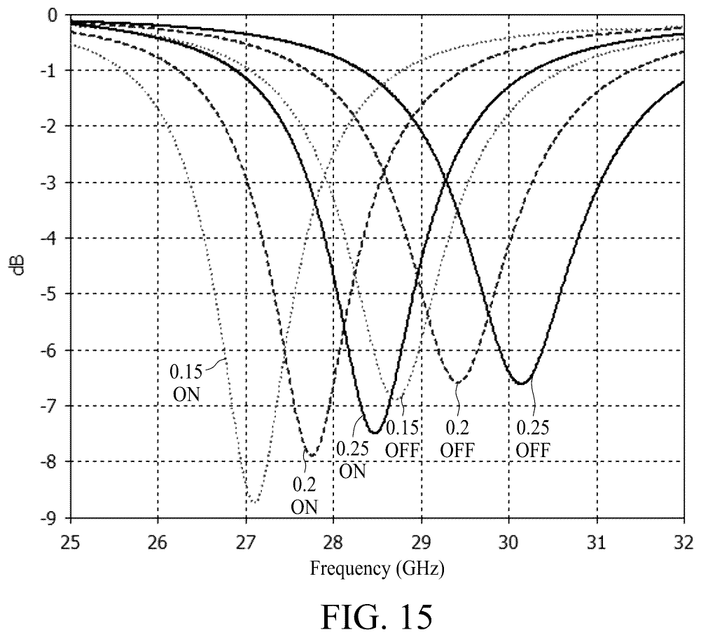

FIG. 15 is a schematic diagram of a simulation result for the unit cell 131 that includes the second electrode layer 300 containing the base portions 324 with different lengths L3 in accordance with some embodiments of the present disclosure. Referring to FIGS. 12 and 15, the six lines as labeled represent the simulation results for the base portions 324 having the length L3 of 0.15 mm, 0.2 mm, and 0.25 mm in a power-on state and in a power-off state. As shown in FIG. 15, the resonant frequency of the unit cell 131 shifts toward a low frequency when the length L3 is reduced. In addition, the resonant frequency is lower during the power-on state than during the power-off state.

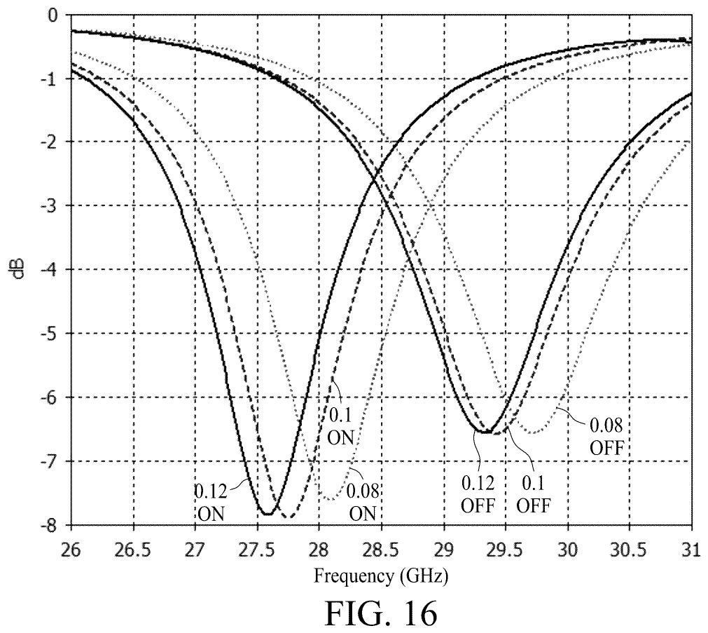

FIG. 16 is a schematic diagram of a simulation result for the unit cell 131 that includes the second electrode layer 300 containing the trenches 340a to 340d with different lengths L4 in accordance with some embodiments of the present disclosure. Referring to FIGS. 12 and 16, the six lines as labeled represent the simulation results for the trench 340a to 340d having the length L4 of 0.08 mm, 0.1 mm, and 0.12 mm in a power-on state and in a power-off state. As shown in FIG. 16, the resonant frequency of the unit cell 131 shifts toward a high frequency when the length L4 is reduced.

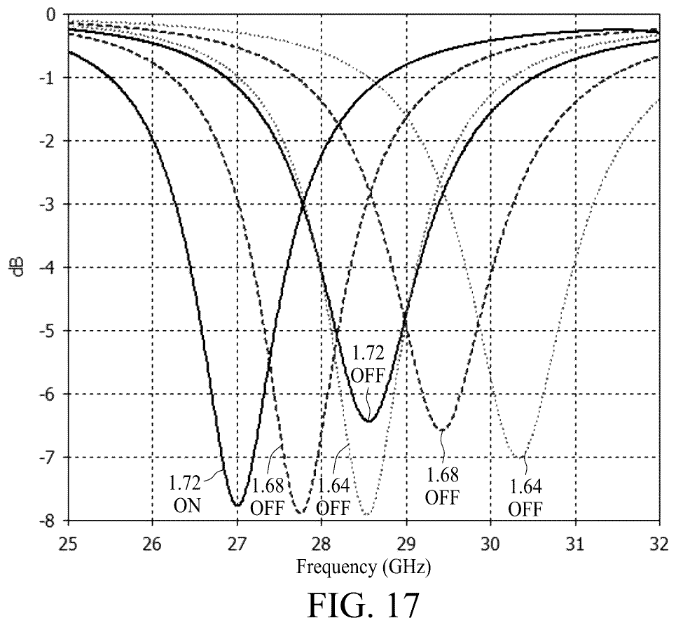

FIG. 17 is a schematic diagram of a simulation result for the unit cell 131 that includes the second electrode layer 300 having different lengths L5 in accordance with some embodiments of the present disclosure. Referring to FIGS. 12and 17, the six lines as labeled represent the simulation results for the second electrode layer 300 having the length L5 of 1.72 mm, 1.68 mm, and 1.64 mm in a power-on state and in a power-off state. As shown in FIG. 17, the resonant frequency of the unit cell 131 shifts toward a high frequency when the length L5 is reduced.

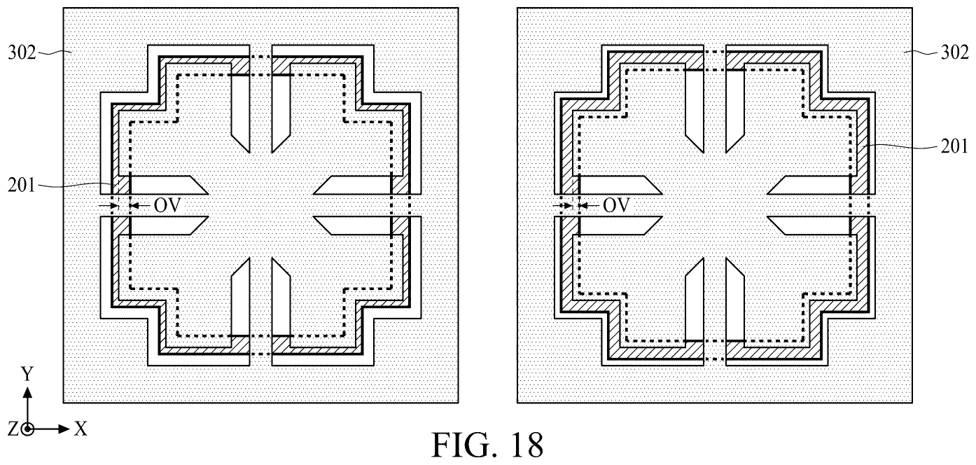

FIG. 18 shows schematic top views of the stacked first and second electrode layers 200 and 300 with different overlapping distances in accordance with some embodiments of the present disclosure. Referring to FIG. 18, the first and second electrode layers 200 and 300 overlap one another with an overlapping distance OV. The overlapping distance OV may be a distance between an inner boundary 204 of the first electrode layer 200 and an edge of the second branch portion 328 interfacing with the first portion 342 of the trench 340a. The overlapping distance OV may affect a resonant frequency of the unit cell 131.

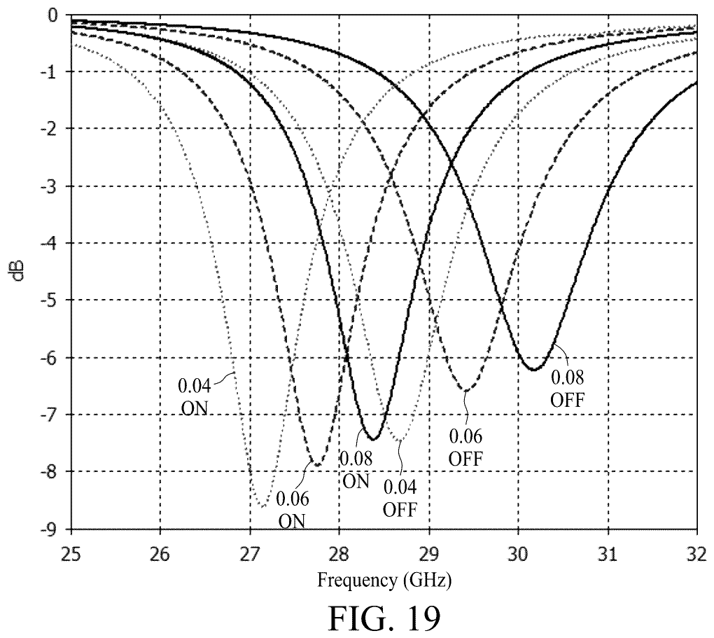

FIG. 19 is a schematic diagram of a simulation result for the unit cell 131 that includes the overlapping distance OV between the first and second electrode layers 200 and 300 in accordance with some embodiments of the present disclosure. Referring to FIGS. 18 and 19, the six lines as labeled represent the simulation results for the first and second electrode layers 200 and 300 having the overlapping distance OV of 0.04 mm, 0.06 mm, and 0.08 mm in a power-on state and in a power-off state. As shown in FIG. 19, the resonant frequency of the unit cell 131 may shift toward a lower frequency when the overlapping distance OV is reduced. In addition, the operation bandwidth may be reduced when the overlapping distance is reduced.

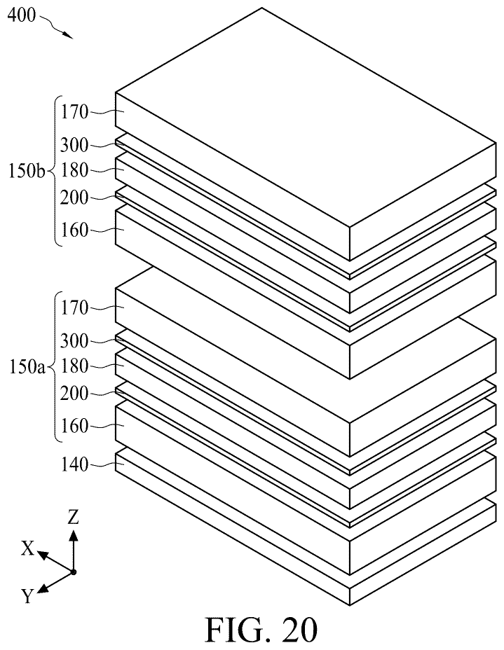

FIG. 20 is a schematic perspective view of a unit cell 400, in accordance with some embodiments of the present disclosure. Referring to FIG. 20, the auxiliary communication device 400 includes a reflective element 140 and two liquid crystal panels 150a and 150b stacked on the reflective element 140. The reflective element 140 is used to reflect EM signals penetrating through the liquid crystal panels 150a and 150b to generate reflected EM signals. The liquid crystal panels 150a and 150b may have a configuration same as that of the liquid crystal panel 150 shown in FIG. 3. In some embodiments, the liquid crystal panels 150a and 150b are configured to provide desired phase shifts for the incident EM signal to be directed in a desired direction towards the receiver 120. The liquid crystal panels 150a and 150b may be configured to provide different resonant frequencies to the incoming EM signals to create the frequency of the cell unit 400 greater than the unit cell 131 shown in FIG. 3. An operation bandwidth of the unit cell 400 is thus increased.

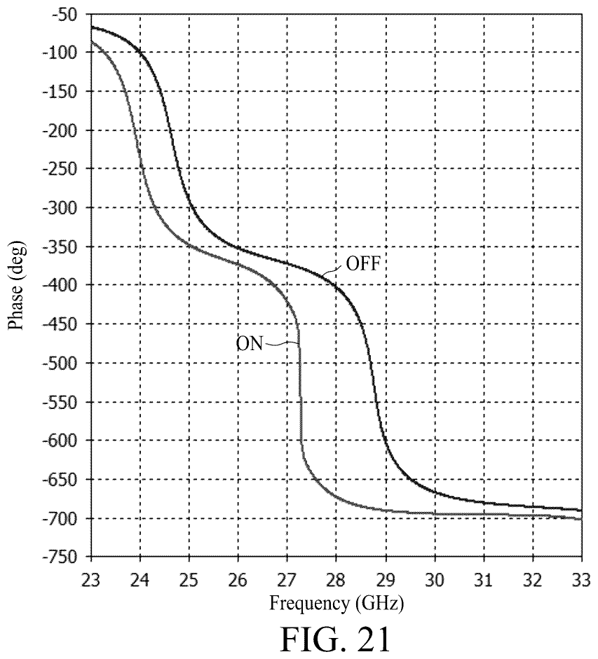

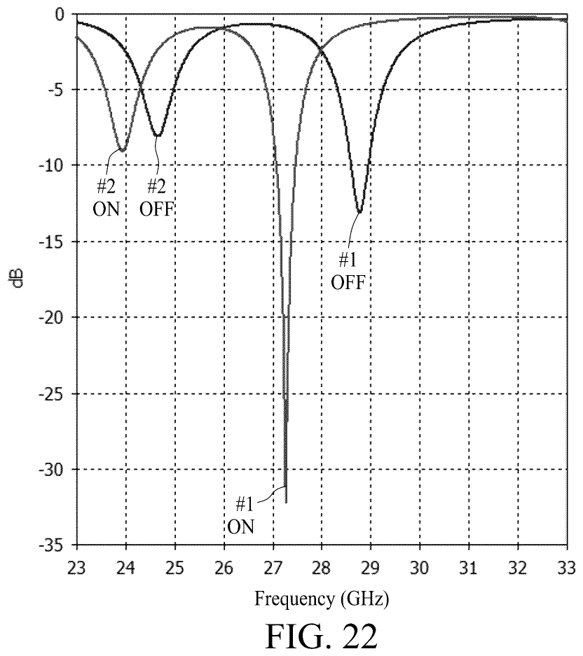

FIG. 21 illustrates a phase response plot of a unit cell, in accordance with some embodiments of the present disclosure, and FIG. 22 illustrates a frequency response plot of a unit cell, in accordance with some embodiments of the present disclosure. The two lines shown in FIGS. 21 and 22 as labeled represent the simulation results for the unit cell 400 in a power-on state and in a power-off state, respectively. At the frequency ranging from about 24 GHz to about 24.5 GHz and the frequency ranging from about 27.5 GHz to about 28.5 GHZ, the unit cell 400 may shift a phase of an incoming EM signal to have a phase difference of about 120 degrees and about 180 degrees, respectively, between the power-on and power-off states. The unit cell 400 may have resonant frequencies of about 24.6 GHz and about 28.7 GHZ in the power-off state. The unit cell 400 may have resonant frequencies of about 24 GHz and about 27.2 GHz in the power-on state.

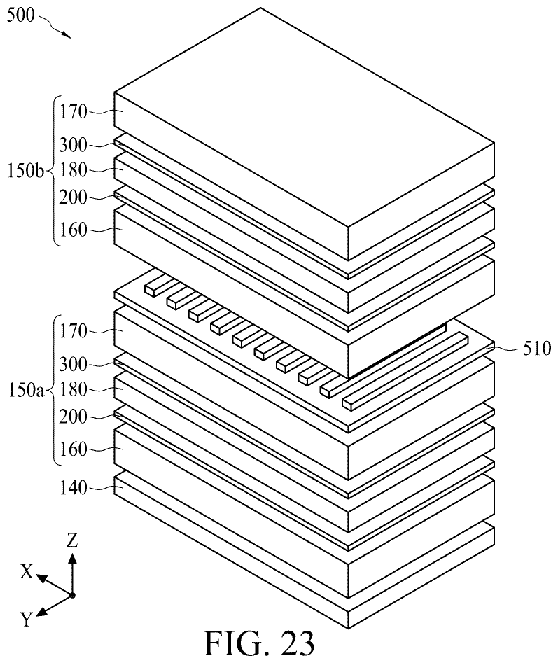

FIG. 23 is a schematic perspective view of a unit cell 500, in accordance with some embodiments of the present disclosure. Referring to FIG. 23, the unit cell 500 includes a reflective element 140, two liquid crystal panels 150a and 150b stacked on the reflective element 140, and a polarizer 510. The reflective element 140 is used to reflect EM signals penetrating through the liquid crystal panels 150a and 150b to generate reflected EM signals. The liquid crystal panels 150a and 150b may have a configuration same as that of the liquid crystal panel 150 shown in FIG. 3. The polarizer 510 is disposed between the liquid crystal panels 150a and 150b. The polarizer 510 is configured to filter desired EM signals.

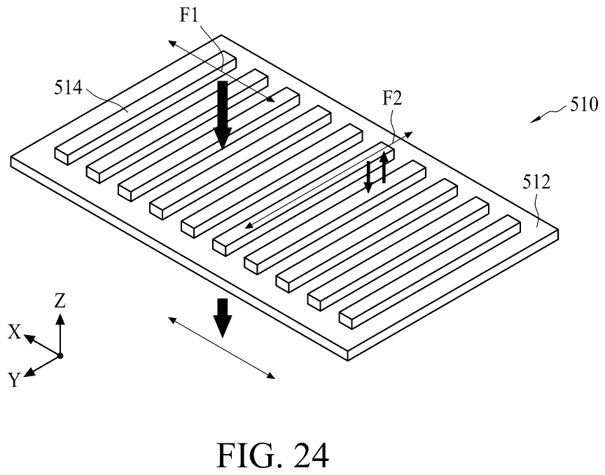

FIG. 24 is a schematic perspective view of the polarizer 510, in accordance with some embodiments of the present disclosure. Referring to FIGS. 23 and 24, the polarizer 510 may include a circuit board 512 and a plurality of metal lines 514 disposed on the circuit board 512. In some embodiments, the circuit board 512 is proximal to the reflective element 140, and the metal lines 514 are distal from the reflective element 140. In alternative embodiments, the circuit board 512 is distal form the reflective element 140, and the metal lines 512 are proximal to the reflective element 140.

An EM signal passing through the liquid crystal panel 150b may further be transmitted through the polarizer 510 when a direction of an electric field F1 of the EM signal is orthogonal to the metal lines 514. An EM signal passing through the liquid crystal panel 150b may be reflected by the polarizer 510 when a direction of an electric field F2 of the EM signal is parallel to the metal lines 514. Due to the polarizer 510, the incoming EM signals with vertical and horizontal polarizations may be shifted to different phases individually.

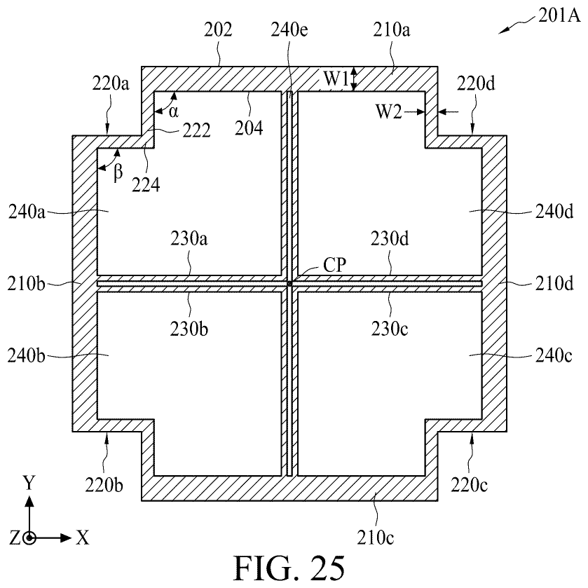

FIG. 25 is a schematic top view of a first pattern 201A, in accordance with some embodiments of the present disclosure. In some embodiments, the first pattern 201A is provided on the first electrode layer 200 of the cells unit 301 shown in FIG. 3. The first pattern 201A is similar to the first pattern 201 discussed above except that that a plurality of L-shaped structures 230a, 230b, 230c and 230d are further included in the first pattern 201A. Furthermore, the dimension of the angled sections 220a to 220d may be altered, and thus, the first pattern 201A includes a non-uniform width.

Referring to FIG. 25, the L-shaped structures 230a to 230d are connected to an inner boundary 204 of the first pattern 201A, forming a plurality of openings 240a to 240e extending through the first electrode layer 200. The L-shaped structure 230a is connected to major sections 210a and 210b. The opening 240a is defined by the L-shaped structure 230a in conjunction with the major sections 210a and 210b and an angled sections 220a. The L-shaped structure 230b is connected to major sections 210b and 210c. The opening 240b is defined by the L-shaped structure 230b in conjunction with the major sections 210b and 210c and an angled section 220b. The L-shaped structure 230c is connected to major sections 210c and 210d. The opening 240c is defined by the L-shaped structure 230c in conjunction with the major sections 210c and 210d and an angled section 220c. The L-shaped structure 230d is connected to major sections 210a and 210d. The opening 240d is defined by the L-shaped structure 230d in conjunction with the major sections 210a and 210d and an angled section 220d.

In some embodiments, the opening 240e is defined by the major sections 210a to 210c and the L-shaped structures 230a to 230d. The opening 240e may have a cross shape with an intersection at a center point CP of the first pattern 210A.

Each of the major sections 210a to 210d has a width W1, and each of the angled sections 220a to 220d has a width W2, wherein the width W2 is less than width W1. Accordingly, the first pattern 201A has a non-uniform width with narrow angled sections 220a to 220d.

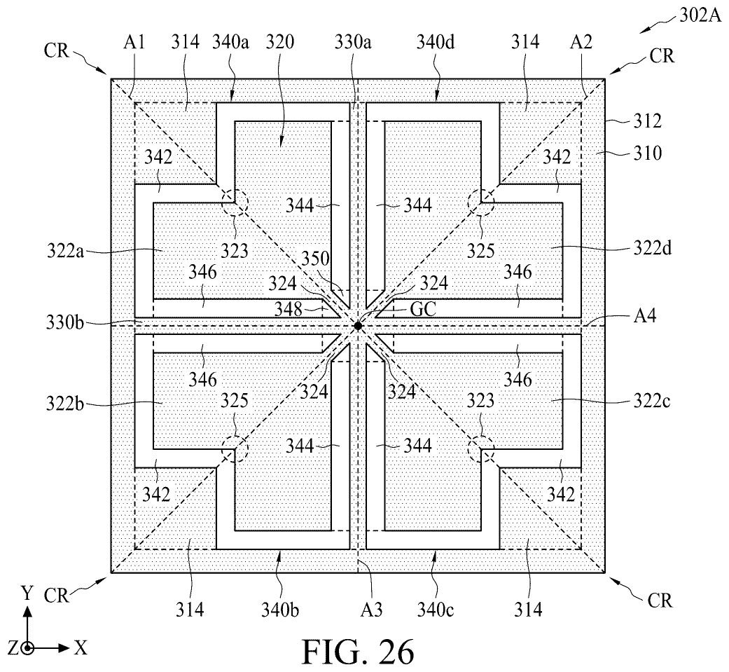

FIG. 26 is a schematic top view of a second pattern 302A, in accordance with some embodiments of the present disclosure. The second pattern 302A is provided on the second electrode layer 300 of the unit cell 302 shown in FIG. 3. The second pattern 302A is similar to the second pattern 302 discussed above except that that the relative dimension of the trenches 340a to 340d may be altered.

Referring to FIG. 26, the second pattern 302a may include trenches 340a to 340d, a longer second portion 344 and a longer third portion 346. The second pattern 302a may thus provide with a narrow connecting section 330a, a narrow connecting section 330b, a narrow outer section 310 with a greater widened portions 314, and a narrow base portion 324 of each Y-shaped structure 322a to 322d. The second pattern 302A may further include fourth portions 348 and fifth portions 350 of the trenches 340a to 340d closer to a geometric center GC of the second electrode layer 200 as compared to the second pattern 302 shown in FIG. 6.

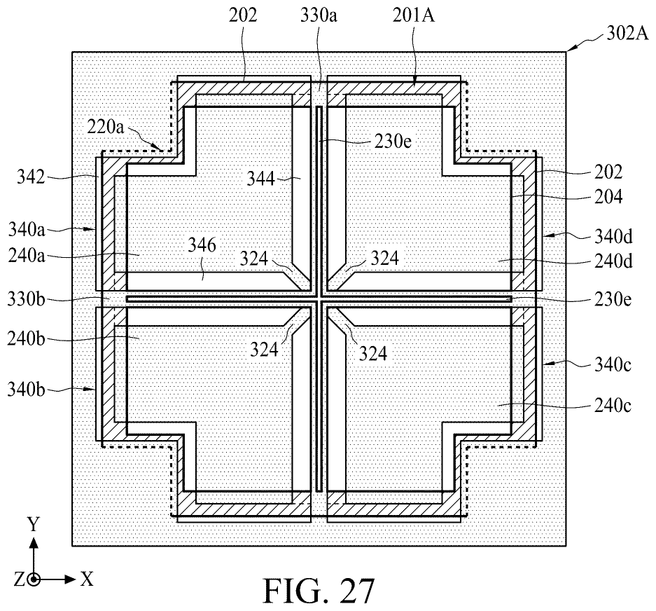

FIG. 27 is a schematic top view of a first electrode layer 200 and a second electrode layer 300, in accordance with some embodiments of the present disclosure. Referring to FIG. 27, the second electrode layer 300 with the second pattern 302A is disposed over the first electrode layer 200 with the first pattern 201A, and the geometric center GC of the second electrode layer 300 is vertically aligned with the center point CP of the first electrode layer 200. The first portions 342 of the trenches 340a to 340d in the second pattern 302A may overlap the outer boundary 202 of major sections 210a to 210d and the inner boundary 204 of the angled sections 220a to 220d in the first pattern 201A form a top-view perspective. The connecting sections 330a and 330b in the second pattern 302A may overlap the opening 230e in the first pattern 201A.

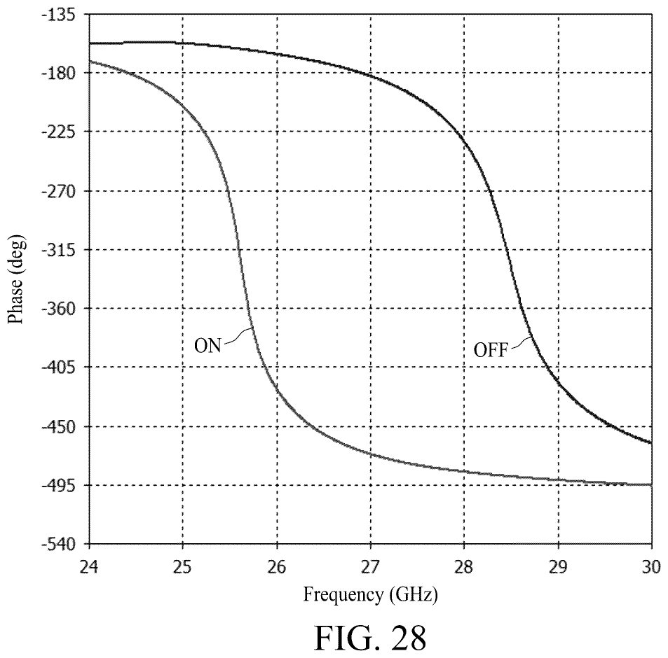

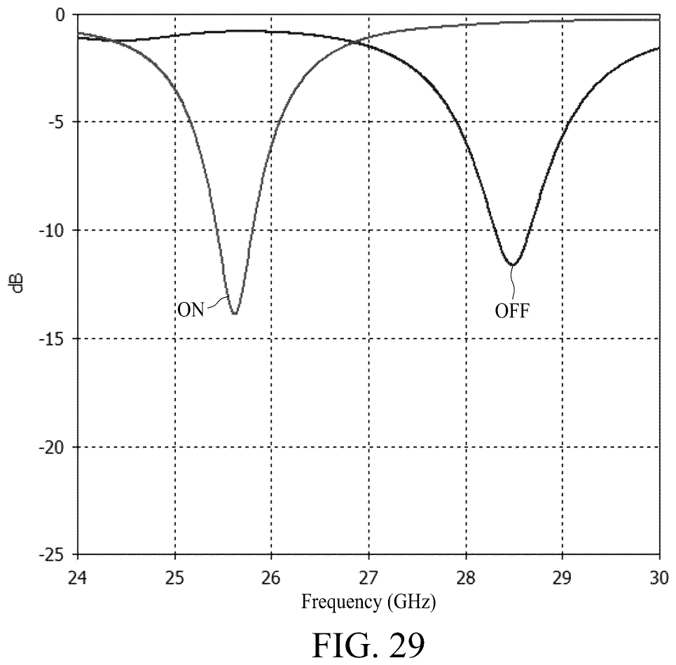

FIG. 28 illustrates a phase response plot of the unit cell 131, in accordance with some embodiments of the present disclosure, and FIG. 29 illustrates a magnitude response plot of a unit cell 131, in accordance with some embodiments of the present disclosure. The two lines in FIGS. 28 and 29 as labeled represent the simulation results for the unit cell 131 including the first electrode layer 200 with the first pattern 201A and the second electrode layer 300 with the second pattern 302A in a power-on state and in a power-off state. Referring to FIG. 28, at the frequency ranging from about 25.7 GHZ to about 28.5 GHz, the unit cell 131 may shift a phase of an incoming EM signal to have a phase difference of about 180 degrees. Referring to FIG. 29, the unit cell 131 in the power-off state has a resonant frequency at about 28.5 GHZ, the unit cell 131 in the power-on state has a resonant frequency at about 25.7 GHZ.

The foregoing outlines features of several embodiments so that those skilled in the art may better understand aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A communication device, comprising:
a plurality of unit cells arranged in a matrix along a row direction and a column direction, wherein each of the unit cells comprises:
a reflective element;
a first substrate disposed on the reflective element;
a liquid crystal layer disposed over the first substrate;
a second substrate disposed over a liquid crystal layer;
a first electrode layer between the first substrate and the liquid crystal layer and comprising a first pattern; and
a second electrode layer between the second substrate and the liquid crystal layer and comprising a second pattern, wherein the second pattern defines a plurality of trenches overlapping a boundary of the first electrode layer from a top-view perspective.

2. The communication device of claim 1, wherein the first pattern comprises:
a pair of first major sections extending in a first direction;
a pair of second major sections extending in a second direction different from the first direction; and
a plurality of angled sections connecting the first major sections to the second major sections,
wherein the pair of first major sections, the pair of second major sections, and the plurality of angled sections define an opening with a cross shape from a top-view perspective.

3. The communication device of claim 2, wherein the plurality of angled sections are respectively at corner regions of the first electrode layer.

4. The communication device of claim 2, wherein the plurality of angled sections comprise:
a first portion extending in the first direction and connected to an end of the second major sections; and
a second portion extending in the second direction and connecting the first portion to an end of the first major sections.

5. The communication device of claim 4, wherein a first included angle between the first major section and the second portion of each angled section is substantially a right angle, and a second included angle between the second major section and the first portion of each angle section is substantially a right angle.

6. The communication device of claim 1, wherein the second electrode layer comprises:
an outer section;
an inner section spaced apart from the outer section at corner regions by the plurality of trenches; and
a plurality of connecting sections connecting the outer section to the inner section, wherein the plurality of trenches are separated from each other by the plurality of connecting sections.

7. The communication device of claim 6, wherein the inner section comprises a plurality of Y-shaped structures connected to the connecting sections from a top-view perspective.

8. The communication device of claim 7, wherein the plurality of Y-shaped structures comprise a base portion and a pair of branch portions connected to the base portion and interfacing with the one of the trenches.

9. The communication device of claim 6, wherein the inner section of the second pattern is disposed around an inner boundary of the first electrode layer.

10. The communication device of claim 9, wherein the first electrode layer further comprises an outer boundary separated from the inner boundary, and a length of the outer boundary exposed through the plurality of trenches is greater than a length of the inner boundary exposed through the plurality of trenches.

11. The communication device of claim 1, wherein the first electrode layer further comprises a plurality of L-shaped structures connected to the inner boundary to forms a plurality of openings through the first electrode layer.

12. A communication device, comprising:
a plurality of unit cells arranged in a matrix along a row direction and a column direction, wherein each of the unit cells comprises:
a reflective element; and
a plurality of panels vertically stacked on the reflective element, wherein each of the plurality of panels comprises:
a first substrate;
a second substrate over the first substrate;
a liquid crystal layer between the first substrate and the second substrate;
a first electrode layer comprising a first pattern between the first substrate and the liquid crystal layer; and
a second electrode layer comprising a second pattern between the second substrate and the liquid crystal layer, wherein the second pattern defines a plurality of trenches overlapping a boundary of the first pattern from a top-view perspective.

13. The communication device of claim 12, further comprising a polarizer between two adjacent panels, wherein the polarizer comprises:
a circuit board; and
a plurality of metal lines parallel to one another on the circuit board.

14. The communication device of claim 13, wherein the circuit board is proximal to the reflective element, and the metal lines are distal from the reflective element.

15. The communication device of claim 12, wherein the first pattern comprises a ring shape from a top-view perspective.

16. The communication device of claim 12, wherein the first pattern has a plurality of sections with a uniform width or a non-uniform width from a top-view perspective.

17. The communication device of claim 12, wherein the first pattern comprises a plurality of angled sections disposed respectively at corner regions of the first pattern, and each of the angled sections has a vertex pointing to a geometric center of the first pattern.

18. The communication device of claim 12, wherein the plurality of trenches are respectively disposed at corner regions of the second pattern.

19. The communication device of claim 12, wherein the second pattern comprises:
an outer section;
an inner section spaced apart from the outer section at corner regions by the plurality of trenches; and
a plurality of connecting sections connecting the outer section to the inner section, wherein the plurality of trenches are separated from each other by the plurality of connecting sections.

20. The communication device of claim 19, wherein the plurality of trenches extend along an outer boundary of the first electrode layer.
